(19) United States
(12) Patent Application Publication
(10) Pub. No.: US 2014/0300311 A1
(43) Pub. Date: Oct. 9, 2014

(54) PORTABLE POWER BANK AND BATTERY BOOSTER

(71) Applicant: Magnadyne Corporation, Compton, CA (US)

(72) Inventors: Barry L. Caren, Beverly Hills, CA (US); C.M. WONG, Scarborough (CA)

(73) Assignee: Magnadyne Corporation, Compton, CA (US)

(21) Appl. No.: 14/108,884

(22) Filed: Dec. 17, 2013

Related U.S. Application Data
(60) Provisional application No. 61/809,725, filed on Apr. 8, 2013.

(51) Int. Cl. H02J 7/00

(52) U.S. Cl. CPC H02J 7/0054
USPC 320/103

(57) ABSTRACT

An apparatus for charging and discharging an electrical device in vehicle is provided. The apparatus comprises a switch, first and second power sources, and first and second contactors. The first power source is configured to provide a low voltage. The switch is configured to enable/disable the first power source. The second power source is configured to provide a high voltage for charging the electrical device. The first contactor is operably coupled to the first power source and to the second power source, the first contactor being configured to enable the second power source to provide the high voltage for charging the electrical device in response to the switch enabling the first power source. The second contactor is operably coupled to the first power source and to the second power source, the second contactor being in an open state in response to the switch enabling the first power supply.

### CROSS-REFERENCE TO RELATED APPLICATIONS

This application claims the benefit of U.S. provisional application Ser. No. 61/809,725 filed Apr. 8, 2013, the disclosure of which is hereby incorporated in its entirety by reference herein.

### TECHNICAL FIELD

This disclosure relates to recharging a battery in a device from a portable back-up battery.

### BACKGROUND

Mobile consumer products such as cell phones, tablet computers, audio players, portable video players, video games and the like use rechargeable batteries. The device battery may be depleted when a device is used extensively. In an effort to address this problem, portable battery packs are available that can provide additional power to recharge the battery of a device after the device's battery is depleted. Vehicle power adapters are also used to recharge device batteries from a vehicle power source that is generally the 12V battery.

It is generally desirable to charge a rechargeable battery as quickly as possible. There are limitations on battery charger designs and on how fast a rechargeable battery can be charged based upon the underlying battery chemistry. For Nickel-based batteries, it is desirable to charge the battery with a constant current source. When using a constant current source, the current applied to the battery can be adjusted to allow for a slow, normal, or fast charge rate. For Lithium-based batteries, it is desirable to have a constant current applied to the battery until the battery reaches full charge. Another charging strategy is to provide the constant current until the battery voltage reaches a threshold voltage and then reducing the charge current. This method requires the input current to be monitored with the charge current being adjusted until the battery is charged.

Battery manufactures specify a stated battery discharge capacity “C” which is measured as a function of current per unit time or more specifically milliampere—hours. This capacity is used to determine the correct charge current and the correct charge time based on an applied current. It also is used to calculate the threshold current at which point the battery is charged. A charging system is specified by the charger output voltage and the maximum allowable current at that output voltage.

Batteries also have a rated operating voltage, if that voltage is exceeded, the battery may malfunction. Electrical and electronic equipment may be designed to operate at a variety of different voltages and currents. Batteries for these electronic devices are configured to support the desired operating voltages and currents. Different operating voltages and currents may be obtained by connecting multiple battery cells in parallel, series or a combination of both.

Available charging devices such as a portable battery, a vehicle power adapter, or AC/DC transformers provide a predetermined level of DC voltage or DC current to recharge the battery of the device. Cell phones have been developed that are capable of changing the voltage received from a charging device to accelerate charging the device's battery from an AC/DC transformer. Currently, there is no convenient way to charge a cell phone from a vehicle power adapter or a battery pack at any voltage other than the predetermined voltage level that provides a normal charging rate.

This disclosure is directed to solving the above problems and other problems as summarized below.

### SUMMARY

A portable smart battery booster is disclosed that can communicate with an electrical or electronic device and adjusts the charging voltage to meet the requirements of electrical or electronic device. A variety of different voltages and currents may be required for different electrical and electronic devices. Smart electrical or electronic devices may be enabled to be charged at a higher voltage that is controlled by the devices to facilitate a rapid charge mode.

According to one aspect of this disclosure, the charger communicates with the smart electrical or electronic device in response to communication from the electrical or electronic device. The portable smart battery booster adjusts the charging output voltage to meet the voltage requirements of the smart electrical or electronic device. The portable smart battery booster may communicate with multiple smart devices to allow charging a variety of smart devices from a single portable smart battery booster. This disclosure solves the problem of providing multiple output voltages from a single portable smart battery booster having an internal battery pack.

Another aspect of this disclosure is that the portable smart battery booster output voltage may be controlled by either hardware or software.

Another aspect of this disclosure is that the charging power may be provided by a portable battery pack, a DC adapter, or an AC adapter.

A further aspect of this disclosure is that the portable smart battery booster contains an internal battery pack that stores charge that is used to provide the energy to generate the output voltage and current.

The above aspects and other aspects of this disclosure are described below in greater detail with reference to the attached drawings.

### BRIEF DESCRIPTION OF THE DRAWINGS

FIG. 1 is a block diagram of a portable smart battery booster with an integrated internal battery pack where the output voltage is changed via hardware;

FIG. 2 is a block diagram of a portable smart battery booster with an integrated internal battery pack where the output voltage is changed via software;

FIG. 3 is a block diagram of the energy flow from a AC or DC power source to the portable smart battery booster, and then to the smart device;

FIG. 4 is a block diagram of the energy flow from a AC or DC power source to the portable smart battery booster; and

FIG. 5 is a block diagram of the energy flow from the portable smart battery booster to the smart device.

### DETAILED DESCRIPTION

This disclosure describes several different embodiments of a battery booster. The disclosed embodiments are intended as examples and other embodiments can take various and alternative forms. The figures are not necessarily to scale and some features may be exaggerated or minimized to show details of particular components. The specific structural and functional details of the examples specifically disclosed are not to be interpreted as limiting, but merely as a representative basis for teaching one skilled in the art how to make and use the present invention. The features illustrated and described with reference to any one of the figures can be combined with features illustrated in one or more other figures to produce embodiments that are not explicitly illustrated or described.

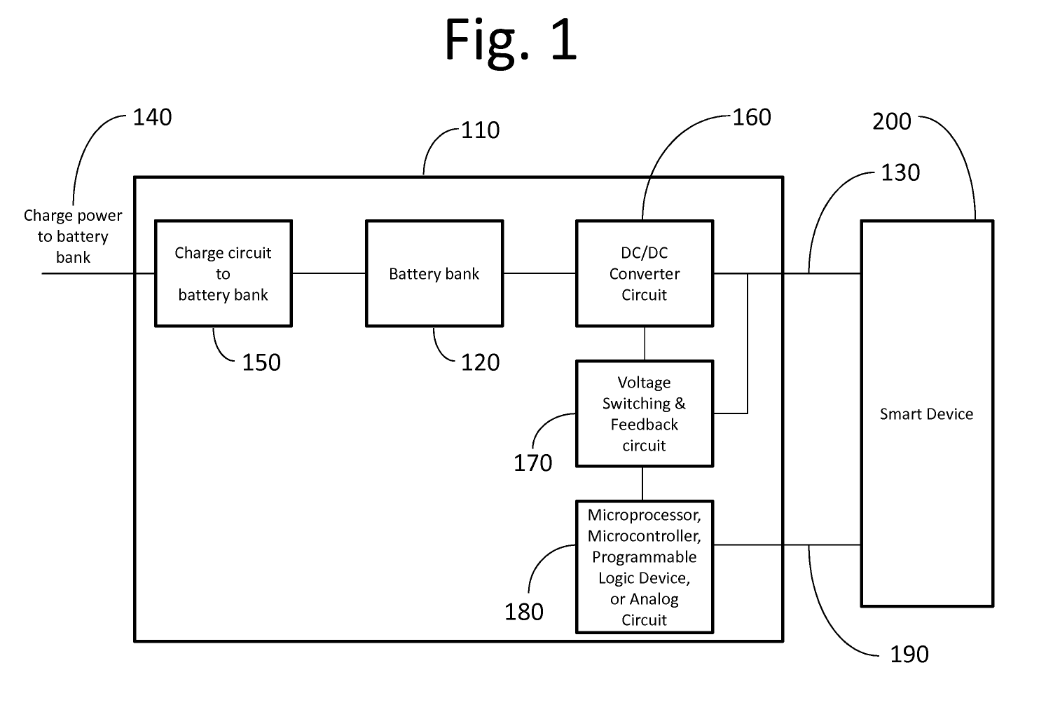

FIG. 1 is a block diagram of a portable smart battery booster 110 with an integrated internal battery pack 120 that may be a single rechargeable cell, or a plurality of rechargeable cells configured in series, parallel or some combination thereof. The battery or plurality of battery cells has a cell voltage which can vary (e.g. 3.7 volts for a Lithium-ion battery, 1.5 volts for a Nickel-Metal Hydride). The portable power apparatus 110 includes hardware that changes an output voltage 130 to a desired output voltage selected from a plurality of available predetermined output voltages which may be different than the cell voltage. The output may be at a voltage level higher than the battery pack 120 voltage, or the output voltage 130 can be a voltage less than the battery pack 120 voltage. Charge power 140 is supplied to the battery pack 120 by a charge circuit 150. The charge circuit 150 controls the voltage and current applied to the battery pack 120 based on the charge power 140 available and the battery pack 120 state of charge. The charge circuit 150 may consist of a buck or boost converter that generates the required voltage and current. A DC/DC converter circuit 160 converts the battery pack 120 voltage to the desired output voltage 130. The output circuitry may include the DC/DC converter circuit 160 which may include a feedback mechanism 170 that monitors the output voltage 130. The feedback mechanism 170 increases or decreases the output voltage 130 supplied by the output circuitry to maintain the voltage at the preferred voltage level.

A microprocessor, microcontroller, programmable logic device, or other digital circuit or analog circuit 180 has input circuitry which receives communication from the smart device. The input circuitry may include a synchronous or asynchronous input, which may continuously monitor or may sample the signal always or for a predetermined period of time. A single direction communication with a smart electrical or electronic device 200 may provide a digital or analog signal 190 to the portable smart battery booster 110. The signal may be a single wire signal, or a multiple wire signal may be used to encode a signal like a bus or differential pair, for example, a protocol using two wires could be USB. The signal may be current or voltage based, (e.g. a voltage level, differential voltage level, or change in voltage). This signal may also be bi-directional. The smart electrical or electronic device 200 may provide the digital or analog signal 190 to the portable smart battery booster 110. If the signal is a bi-directional signal, the signal may include software or hardware handshaking The bidirectional communication enables the smart device 200 to send a signal to the portable smart battery booster 110 indicating the desired voltage output 130 for charging the smart device.

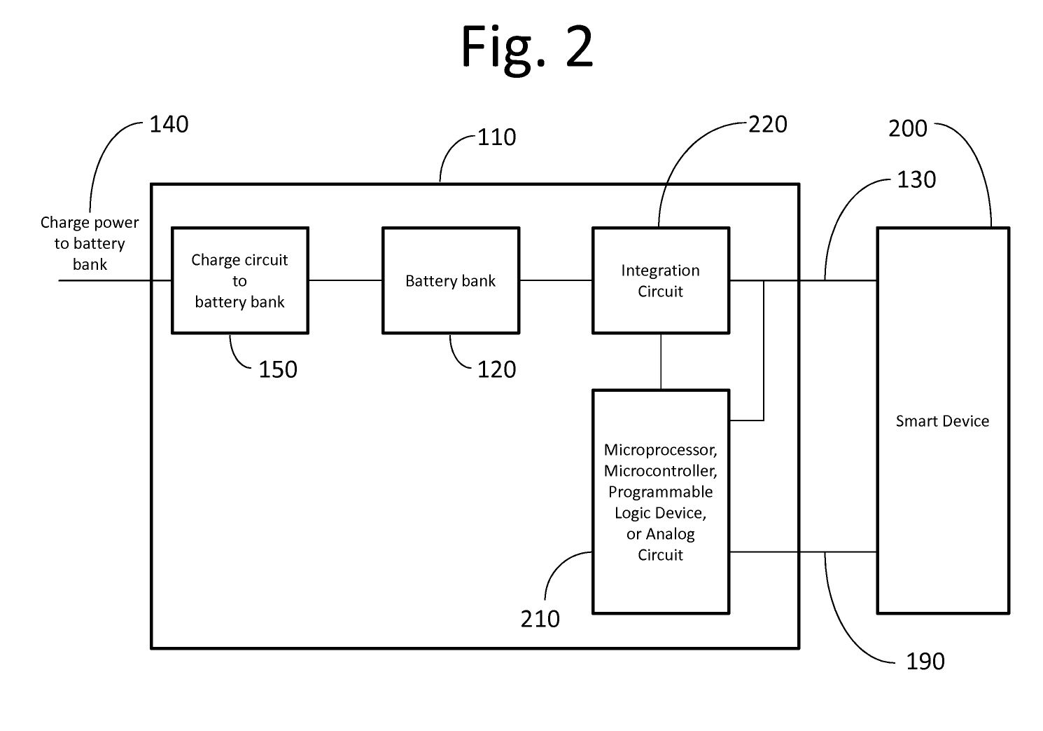

FIG. 2 is a block diagram of the portable smart battery booster 110 with the integrated internal battery pack 120 that includes software that changes the output voltage 130. Charge power 140 is supplied to the battery pack 120 by the charge circuit 150. The charge circuit controls the voltage and current applied to the battery pack 120 based on the charge power 140 available and the battery pack 120 state of charge. The charge circuit may consist of a buck or boost converter that generates the required voltage and current. The DC/DC converter circuit 160 converts the battery pack 120 voltage to the desired output voltage 130 using a pulse width modulation (PWM) signal. The PWM signal is integrated and the integral of the PWM duty cycle provides the desired output voltage 130.

The microprocessor, microcontroller, or programmable logic device 210 generates the PWM signal and receives feedback from the integration circuit 220. The feedback mechanism monitors the output voltage 130 and microprocessor, microcontroller, or programmable logic device 210 increases or decreases the PWM duty cycle increasing or decreasing of the output voltage 130 to maintain the voltage at the level requested by the smart device 200. The microprocessor, microcontroller, programmable logic device, or other digital circuit or analog circuit 210 is used to communicate with the smart device 200. A single direction communication with the smart electrical or electronic device 200 provides the digital or analog signal 190 to the portable smart battery booster 110. The signal also may be a single wire signal, or a multiple wire signal may be used to encode the signal such as a bus or differential pair. If the signal is a bi-directional signal, the signal may include software or hardware handshaking The bidirectional communication enables the smart device 200 to send the signal to the portable smart battery booster 110 indicating the desired voltage output 130 for charging the smart device.

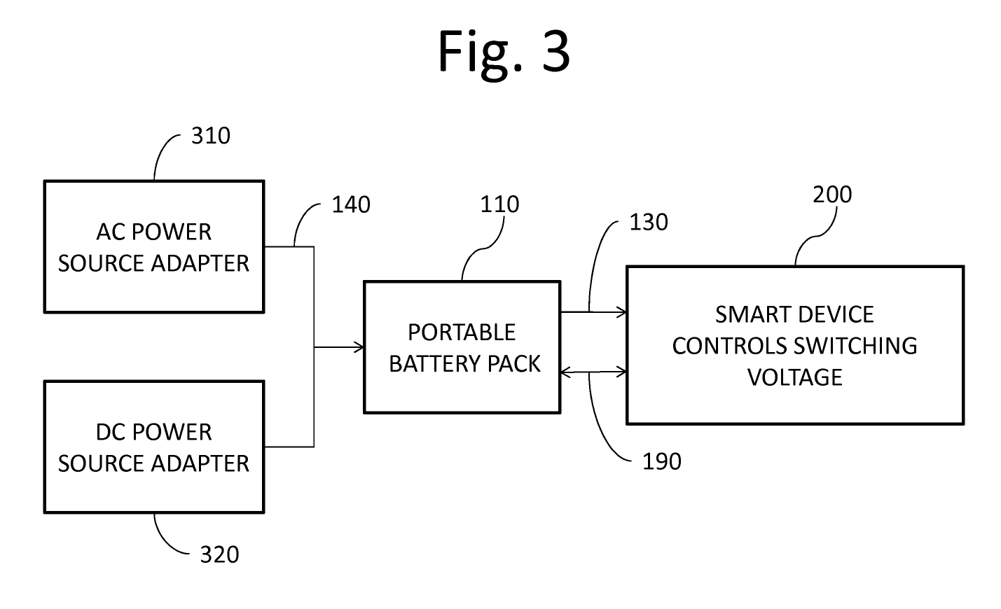

FIG. 3 is a block diagram of the energy flow from an AC power source 310 or DC power source 320 to the portable smart battery booster 110 with an integrated internal battery pack and then to the smart device 200. The AC power source may consist of standard 50 or 60 Hertz, 110 or 220 volt system or may be at the standard frequency or voltage available from the electrical utility grid. The AC power source adapter 310 converts the voltage from the utility grid voltage and frequency to the standard voltage 140 accepted by the portable battery pack 110. The DC power source 320 converts the DC voltage to the standard voltage 140 accepted by the portable smart battery booster 110. The portable smart battery booster 110 is connected to the smart device 200 to form the communication link 190. A unidirectional communication with the smart device 200 may need to send a message to the portable smart battery booster 110 to indicate the charging voltage 130. In another embodiment, the communication link 190 may be a bidirectional link that sends messages back and forth between the smart device 200 and the portable smart battery booster 110. The bidirectional link enables the portable smart battery booster 110 and smart device 200 to acknowledge that the messages are properly received and confirmed before providing the required voltage output 130.

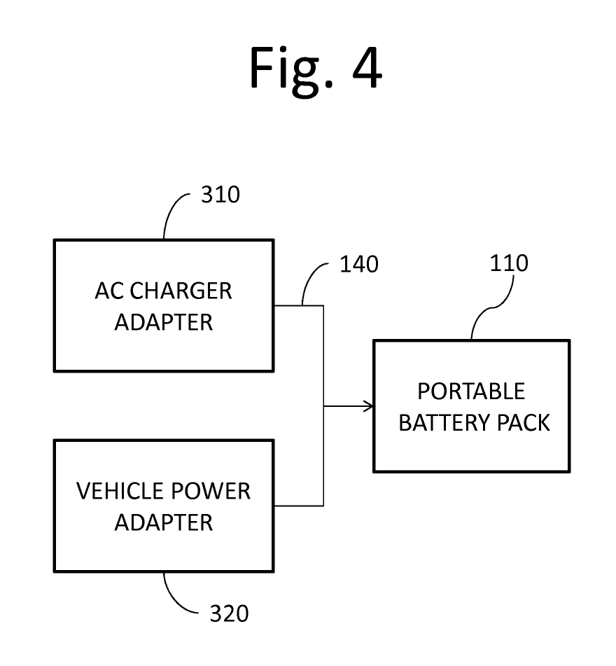

FIG. 4 illustrates a block diagram of the energy flow from the AC power source 310 or DC power source 320 to the portable smart battery booster 110 with an integrated internal battery pack. As illustrated, the portable smart battery booster 110 with an internal battery pack is charged separately from the smart device 200. The AC power source may consist of the standard 50 or 60 Hertz, 110 or 220 volt system or may be at the standard frequency or voltage available from the electrical utility grid. The AC power source adapter 310 converts the voltage from the utility grid voltage and frequency to the standard voltage 140 accepted by the portable smart battery booster 110. Likewise, the DC power source 320 will convert the DC voltage to the standard voltage 140 accepted by the portable battery pack 110.

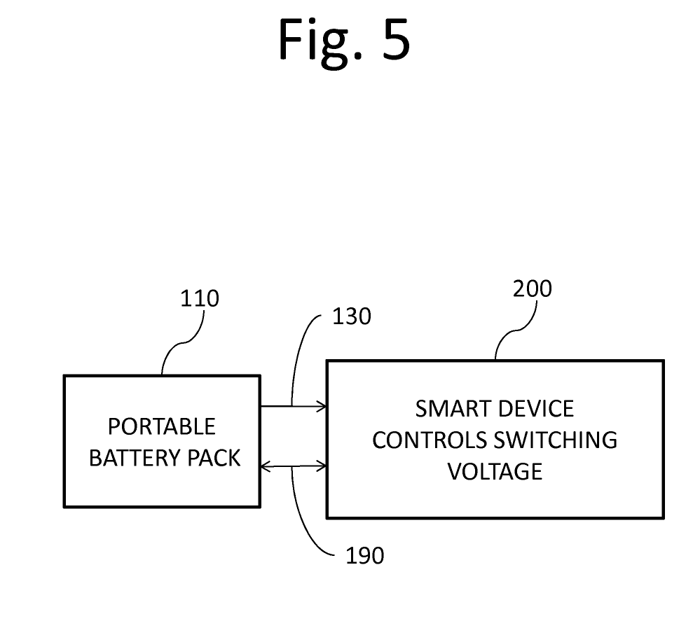

FIG. 5 is a block diagram of the energy flow from the portable smart battery booster 110 with an integrated internal battery pack to the smart device 200. The smart device 200 may be a portable cellular phone, a portable electronic tablet, an electronic game or any electrical device equipped to communicate via the standard used by the communication link 190. The communication link 190 may use a dedicated wire, or multiple wires may be used to encode a signal like a bus or differential pair. An example would be a USB connector with a 4 pin interface with pin 1 being Vcc, pin 2 being Data-, pin 3 being Data+and pin 4 being Gnd. In this example, the signal would be the Data- and Data+pins, and the output would be the voltage applied between Vcc and Gnd. The portable smart battery booster 110 has an internal battery pack that stores the energy used to charge a variety of different smart devices 200. The single portable smart battery booster 110 is capable of charging a variety of different smart devices 200 that may require different voltages to charge. The portable smart battery booster 110 automatically generates the suitable voltages for each smart device 200.

The disclosed processes, methods, or algorithms can be implemented by a processing device, controller, or computer that can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic data tape storage, optical data tape storage, CDs, RAM devices, FLASH devices, MRAM devices and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers, or any other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated.

While various embodiments could have been described as providing advantages or being preferred over other embodiments or prior art implementations with respect to one or more desired characteristics, one or more features or characteristics can be compromised to achieve desired overall system attributes, depending upon the specific application and implementation. These attributes can include, but are not limited to cost, strength, durability, life cycle cost, marketability, appearance, packaging, size, serviceability, weight, manufacturability, ease of assembly, etc. Embodiments described as less desirable than other embodiments or prior art implementations with respect to one or more characteristics can be desirable for particular applications.

What is claimed is:

1. A portable power apparatus for charging an electrical device having a rechargeable battery, the apparatus comprising:
at least one rechargeable cell having a cell voltage;
input circuitry having a first input and second input, configured to receive a voltage preference setting signal from the electrical device, the voltage preference setting is encoded by a first voltage level and a second voltage level applied to the first input and second input; and
output circuitry configured to provide power from the rechargeable cell to the electrical device at one of a plurality of predetermined output voltages selected in response to the voltage preference setting that is different than the cell voltage.

2. The apparatus of claim 1, wherein the rechargeable cell is a plurality of rechargeable cells.

3. The apparatus of claim 1, wherein the voltage setting preference signal is based on sampling the first input and second input within a predefined sampling window of time.

4. The apparatus of claim 1, further comprising:
a controller programmed to cause the output circuit to achieve one of the plurality of predetermined output voltages selected to change a rate at which the rechargeable cell provides current to the battery in response to a signal from the electrical device electrically connected with the output circuit.

5. A method for charging an electrical device by a variable voltage portable power pack, the method comprising:
receiving at least one differential voltage setting preference signal;
selecting an output voltage of a charger from a plurality of predefined voltages based on the at least one voltage setting preference signal; and
charging the electrical device with energy transferred from the charger at the selected output voltage.

6. The method of claim 5, wherein the at least one differential voltage setting preference signal includes two differential voltage setting preferences signals.

7. A portable power pack for charging a battery of a portable electrical device comprising:
at least one rechargeable cell having a cell voltage;
an output electrically connected with the cell; and
a controller configured to cause the output to achieve one of a plurality of predefined voltages that is different than the cell voltage, selected in response to a signal from a portable electrical device electrically connected to the portable power pack.

8. The portable power pack of claim 7, wherein the controller includes a first input and a second input, wherein the one of a plurality of predefined voltages is selected in response to combinations of predetermined voltage levels on the first input and second input.
